(19) United States
(12) Patent Application Publication
(10) Pub. No.: US 2026/0291577 A1
(43) Pub. Date: Sep. 24, 2026

(54) CSI REPORTING FOR CELL ACTIVATION

(71) Applicant: Nokia Technologies Oy, Espoo (FI)

(72) Inventors: Lei DU, Beijing (CN); Lars DALSGAARD, Oulu (FI)

(73) Assignee: Nokia Technologies Oy, Espoo (FI)

(21) Appl. No.: 19/473,926

(22) PCT Filed: Apr. 10, 2023
(86) PCT No.: PCT/CN2023/087387

§ 371 Date: Oct. 9, 2025

(51) Int. Cl. H04B 7/06

(52) U.S. Cl. CPC H04B 7/0626; H04B 7/06952

(57) ABSTRACT

Example embodiments of the present disclosure relate to methods, devices, apparatuses and computer readable storage medium for channel state information (CSI) reporting. In a method, a first device receives, from a second device, a beam related indication for a cell. The beam related indication indicates a beam for a communication via the cell. Then, the first device derives a first CSI measurement result based on the received beam related indication. The first device transmits, to the second device, a CSI report to indicate the first CSI measurement result.

### FIELDS

Various example embodiments of the present disclosure generally relate to the field of telecommunication and in particular, to methods, devices, apparatuses and computer readable storage medium for channel state information (CSI) reporting for cell activation.

### BACKGROUND

In New Radio (NR), as in long term evolution (LTE), a secondary cell (SCell) or a primary secondary cell (PSCell) can be activated or deactivated by a network to save user equipment (UE) battery consumption when carrier aggregation (CA) is configured. A SCell status change can be triggered by a SCell activation or deactivation command which may be carried by a medium access control (MAC) control element (CE) and used to indicate if the given SCell needs to be activated or deactivated. When activating a SCell, it may take a certain time for the UE to change the SCell status from a deactivated status to an activated status, thereby inducing an activation delay for transition from a deactivated status to an activated status.

### SUMMARY

In a first aspect of the present disclosure, there is provided a method. The method comprises at a first device, receiving, from a second device, a beam related indication for a cell, the beam related indication indicating a beam for a communication via the cell; deriving a first CSI measurement result based on the received beam related indication; and transmitting, to the second device, a CSI report indicating the first CSI measurement result.

In a second aspect of the present disclosure, there is provided a method. The method comprises at a second device, transmitting, to a first device, a beam related indication for a cell, the beam related indication indicating a beam for a communication via the cell; and receiving, from the first device, a CSI report indicating a first CSI measurement result associated with the beam.

In a third aspect of the present disclosure, there is provided a first device. The first device comprises at least one processor; and at least one memory storing instructions that, when executed by the at least one processor, cause the first device at least to perform: receiving, from a second device, a beam related indication for a cell, the beam related indication indicating a beam for a communication via the cell; deriving a first CSI measurement result based on the received beam related indication; and transmitting, to the second device, a CSI report indicating the first CSI measurement result.

In a fourth aspect of the present disclosure, there is provided a second device. The second device comprises at least one processor; and at least one memory storing instructions that, when executed by the at least one processor, cause the second device at least to perform: transmitting, to a first device, a beam related indication for a cell, the beam related indication indicating a beam for a communication via the cell; and receiving, from the first device, a CSI report indicating a first CSI measurement result associated with the beam.

In a fifth aspect of the present disclosure, there is provided a first apparatus. The first apparatus comprises means for receiving, from a second device, a beam related indication for a cell, the beam related indication indicating a beam for a communication via the cell; means for deriving a first CSI measurement result based on the received beam related indication; and means for transmitting, to the second device, a CSI report indicating the first CSI measurement result.

In a sixth aspect of the present disclosure, there is provided a second apparatus. The second apparatus comprises means for transmitting, to a first device, a beam related indication for a cell, the beam related indication indicating a beam for a communication via the cell; and means for receiving, from the first device, a CSI report indicating a first CSI measurement result associated with the beam.

In a seventh aspect of the present disclosure, there is provided a computer readable medium. The computer readable medium comprises instructions stored thereon for causing an apparatus to perform at least the method according to the first aspect.

In an eighth aspect of the present disclosure, there is provided a computer readable medium. The computer readable medium comprises instructions stored thereon for causing an apparatus to perform at least the method according to the second aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates an example activation procedure for activating an unknown cell according to some example embodiments of the present disclosure;

FIG. 3 illustrates a signaling diagram for CSI reporting according to some example embodiments of the present disclosure;

FIGS. 4A and 4B show example processes of CSI reporting according to some example embodiments of the present disclosure;

FIG. 5 illustrates a flowchart of an example method implemented at a first device in accordance with some example embodiments of the present disclosure;

FIG. 6 illustrates a flowchart of an example method implemented at a second device in accordance with some example embodiments of the present disclosure;

FIG. 7 illustrates a simplified block diagram of a device that is suitable for implementing example embodiments of the present disclosure; and

FIG. 8 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As mentioned above, a SCell can be activated or deactivated by a network to save UE battery consumption when CA is configured. A SCell activation or deactivation command, which may be carried by a MAC CE, can be used to indicate if the given SCell, with SCellIndex I, needs to be activated or deactivated. However, SCell activation may induce a long delay for transition from a deactivated status to an activated status. In some conditions, especially, in higher carrier frequencies such as frequency range 2 (FR2), for an unknown target SCell, the activation delay could become very long due to automatic gain control (AGC), cell detection, Layer 1 (L1) Reference Signal Received Power (RSRP) (L1-RSRP) measurements, Channel-State Information (CSI) measurements, and the like.

It is approved in the third-generation partnership project (3GPP) Release 18 (Rel-18) to reduce the SCell activation delay for SCell activation in FR2. To reduce the overall FR2 SCell activation delay, some activation steps can be reduced or skipped. One of the challenges to address is that no data transmission can in practice be scheduled within the activation period. Hence, the to-be-activated SCell cannot be utilized during the whole activation procedure.

As specified in the 3GPP standards, the UE can report out of range (OR) before an end of SCell activation if the UE has available uplink resources to report a channel quality indicator (CQI) for the SCell for example on a primary cell (PCell). This prevents the UE from indicating any preliminary channel quality before the end of the SCell activation which could have enabled early scheduling of the UE. The UE may have to wait until the end of SCell activation to be able to send a valid CSI report which can reflect the accurate channel conditions, for example, for optimized scheduling. If the UE sends an OoR CSI report, the network may configure a semi-periodic CSI reference signal (SP-CSI-RS) or a periodic-CSI-RS (P-CSI-RS) used for accurate channel measurement and have to wait until a valid CSI report for the SP-CSI-RS or P-CSI-RS is received to start scheduling the data transmission. Based on the content of the received CSI reports, the network may determine whether the SCell is activated. Then, the network may initiate scheduling of the UE after receiving the valid CSI report and be able to benefit from the newly added or activated SCell.

Example embodiments of the present disclosure propose a CSI reporting scheme. With this scheme, after a first device (such as a UE) receives a beam related indication e.g., transmission configuration indication (TCI) activation command for a cell (such as a SCell) from a second device (such as a gNB), the first device derives a CSI measurement result based on the beam related indication. The CSI measurement result may be obtained based on a synchronization signal block (SSB) and/or a CSI reference signal (CSI-RS) that is associated with a beam indicated by the TCI activation command. The SSB and/or CSI-RS may be configured with CSI reporting. Then, the first device transmits, to the second device, a CSI report to indicate the CSI measurement result. Although the present disclosure is described in context of SCell activation, it can also be used for secondary cell group (SCG) activation i.e. to activate a PSCell.

In this way, the first device is not required to wait until it has fully acquired an accurate and valid CSI report (which is reflecting the actual channel conditions) based on a particular CSI-RS used for channel measurement, to transmit a CSI report to the second device. This may allow earlier scheduling of the first device, for example, during the cell activation. For example, the second device may initiate a data transmission based on the “early CSI” report. Hence, an activation delay for a cell to transit from a deactivated status to an activated status may be reduced, and communication efficiency may be improved.

It is to be noted that although the issue is originating from activating an FR2 SCell, there is a similar problem for other frequency ranges and for activating other types of serving cells. Hence, the proposed scheme herein may be applied in general for different frequency ranges including for example both FR1 and FR2, and may also be applied in general for any type of serving cells including both a SCell and a primary SCell (PSCell). In the following, some example embodiments will be described using a SCell as an example while the example embodiments herein can be applied in general for a PSCell and other serving cells.

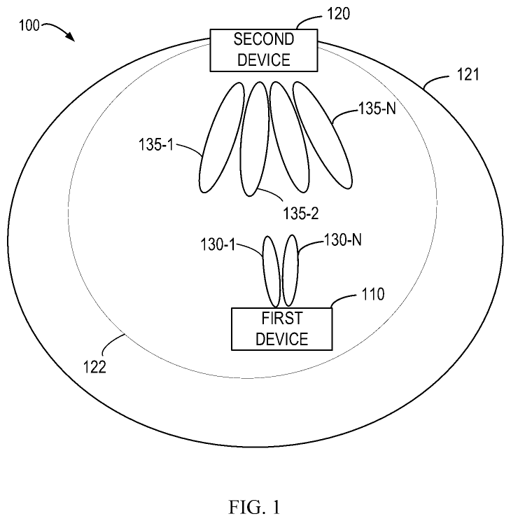

FIG. 1 illustrates an example communication environment 100 in which example embodiments of the present disclosure can be implemented. In the communication environment 100, a plurality of communication devices, including a first device 110 and a second device 120, can communicate with each other.

In the following, for the purpose of illustration, some example embodiments are described with the first device 110 operating as a terminal device and the second device 120 operating as a network device. However, in some example embodiments, operations described in connection with a terminal device may be implemented at a network device or other devices, and operations described in connection with a network device may be implemented at a terminal device or other devices.

In some example embodiments, if the first device 110 is a terminal device and the second device 120 is a network device, a link from the second device 120 to the first device 110 is referred to as a downlink (DL), while a link from the first device 110 to the second device 120 is referred to as an uplink (UL). In DL, the second device 120 is a transmitting (TX) device (or a transmitter) and the first device 110 is a receiving (RX) device (or a receiver). In UL, the first device 110 is a TX device (or a transmitter) and the second device 120 is a RX device (or a receiver).

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

In the environment 100, the first device 110 may have access to a communication network via a plurality of cells, including a first cell 121 (also referred to as Cell1) and a second cell 122 (also referred to as Cell2) for CA, for example. Either or both cells may be provided by the second device 120 or any other suitable devices which may employ the same or different radio access technology. In some example embodiments, the first cell 121 may be a primary cell (PCell), and the second cell 122 may be a primary secondary cell (PSCell) or a secondary cell (SCell). Although two cells 121 and 122 are shown in FIG. 1, less or more cells may be provided for the first device 110.

In some example embodiments, both the first device 110 and the second device 120 may be configured to implement a beamforming technique and communicate with each other via a plurality of beams. As shown in FIG. 1, the first device 110 may be configured with a plurality of beams 130-1, . . . , 130-N, and the second device 120 may be configured with a plurality of beams 135-1, 135-2, . . . , 135-M, where N and M represent any suitable positive integer. There may be different beams configured for the first cell 121 and the second cell 122. For example, a beam 135-2 may be configured for the second cell 122. It is to be understood that the second cell 122 may have more beams associated therewith. Although not shown, the first cell 121 may also have beams associated therewith.

It is to be understood that the numbers of devices, cells and beams are only for the purpose of illustration without suggesting any limitations. The communication environment 100 may include any suitable numbers of devices, cells and beams adapted for implementing embodiments of the present disclosure.

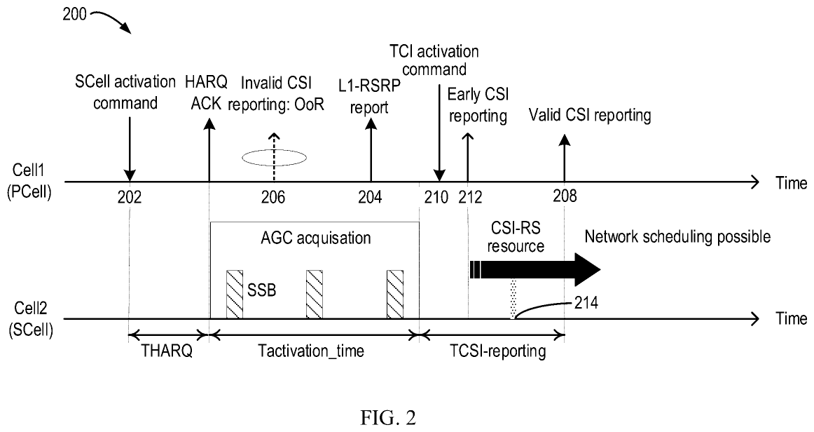

In the environment 100, during cell activation of the second cell 122, the first device 110 may receive from the second device 120 a beam related indication e.g. TCI activation command for the second cell 122. The TCI activation command indicates a beam for a communication via the second cell 122 and it is used to activate the second cell 122. After receiving the TCI activation command, the first device 110 may report measured CSI instead of OoR CSI in a CSI report. An example cell activation procedure will be discussed below with reference to FIG. 2.

FIG. 2 shows an example activation procedure 200 for a cell according to some example embodiments of the present disclosure. In this example, the first cell 121, or Cell1, operates as a PCell, and the second cell 122, or Cell2, operates as a SCell.

As shown in FIG. 2, at a time 202, the first device 110, which may operate as a UE, may receive a SCell activation command for Cell2 from the second device 120, which may operate as a gNB. In some example embodiments, the first device 110 may be allowed to send a Layer 3 (L3) or Layer 2 (L2) measurement report immediately after the SCell activation command (not shown in FIG. 2). The L3 or L2 measurement report may inform the latest beam information of the SCell. In some example embodiments, the first device 110 may have sent a L3 measurement report within a time period before SCell activation command, i.e., the SCell is known. The network may already have the beam information of the known SCell when sending the SCell activation command (not shown in FIG. 2).

At a time 204, the first device 110 may transmit a L1-RSRP measurement report which is also possible with a reduced beam sweeping factor. The L3/L2 measurement report and/or the L1-RSRP measurement report may allow the first device 110 to send beam information as early as possible. This provides opportunity for the network to schedule the first device 110.

At a time 206, the first device 110 may transmit an OoR (or invalid) CSI report to indicate an OoR result of channel measurement on available uplink resources of Cell1 (or PCell). However, after synchronization with the SCell, the first device 110 may be able to monitor a physical downlink control channel (PDCCH) of SCell and thus it is possible to schedule the first device 110 with a data transmission based on a rough beam information. Although the first device 110 may continue configuring the dedicated CSI-RS to be used for the channel measurement and the data transmission may be expected on the refined beams, the data transmission may not be prevented during beam refinement based on the beam information available at the network.

To enable scheduling the first device 110 earlier, from network point of view, a CSI report (instead of the OoR CSI report) for the SCell from the first device 110 may be enabled. As shown in FIG. 2, at a time 210, the first device 110 may receive a TCI activation command. The TCI activation command indicates one or more TCI states or beam(s) which may be determined by the network based on beam information included in the L3/L2 measurement report and/or the L1-RSRP measurement report from the first device 110. At a time 212, the first device 110 may transmit a CSI report which may facilitate early data scheduling during the SCell activation.

For example, based on the CSI report, the network may initiate a data transmission to the first device 110 before configuring CSI-RS resources (at a time 214) for a valid CSI report (at a time 208). With such an earlier data transmission within the activation period, the SCell activation delay is reduced, and the system performance may be improved.

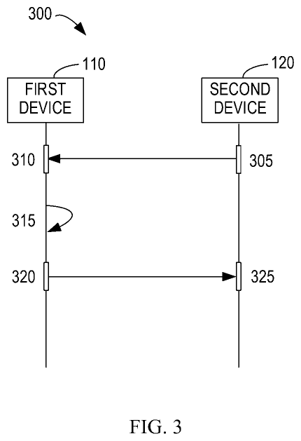

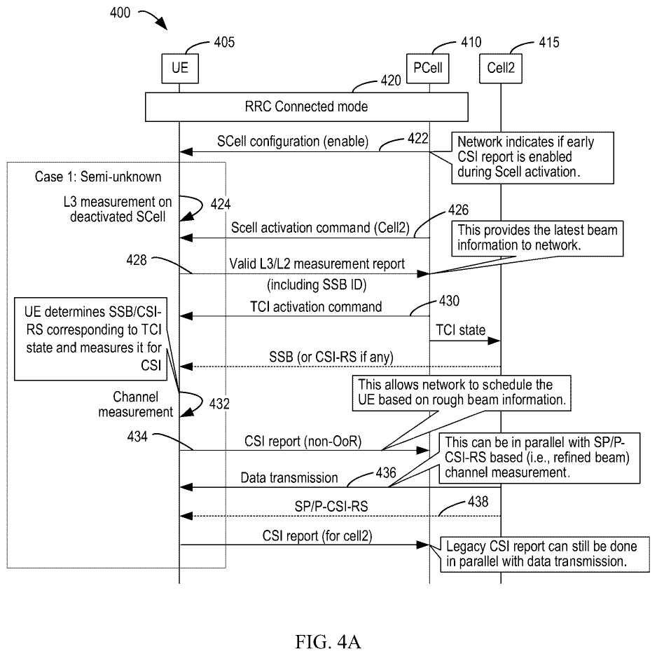

Some example implementations of the present disclosure will be described in detail below with reference to FIGS. 3, 4A and 4B.

FIG. 3 shows a signaling diagram 300 for CSI reporting according to some example embodiments of the present disclosure. For the purpose of discussion, the signaling diagram 300 will be described with reference to FIGS. 1 and 2.

As shown in FIG. 3, the second device 120 (such as a gNB) may transmit (305), to the first device 110 (such as a UE), a beam related indication for a cell such as the second cell 122 or Cell2. The beam related indication may comprise a TCI activation command which indicates at least one TCI state or beam for a communication via the cell. Accordingly, the first device 120 may receive (310) the beam related indication. Then, the first device 110 derives (315) a first CSI measurement result based on the beam related indication.

In some example embodiments, based on the beam related indication, the first device 120 may determine a first reference signal associated with the beam. The first reference signal may include a SSB and/or a CSI-RS corresponding to the beam. The first reference signal is determined as the reference signaling configured with CSI reporting and corresponding to the TCI state indicated in the TCI activation command.

The first device 110 may transmit (320) a CSI report to the second device 120 to indicate the first CSI measurement result based on the TCI activation command and/or the first reference signal. In some example embodiments, the CSI report may be transmitted during a cell activation procedure of the cell. The first CSI measurement result may be obtained based on the first reference signal before or after the TCI activation command depending on the implementation of the configuration for the first reference signal.

In an example, the first device 110 may have obtained some L3/L2 measurements or L1-RSRP measurements based on SSBs before receiving the TCI activation command. In this example, after receiving the TCI activation command, the first device 110 may determine available L3/L2 measurements or L1-RSRP measurements based on the SSBs corresponding to the beam indicated by the TCI activation command and use the CSI report to indicate the corresponding measurement result.

In another example, the first device 110 may be configured a CSI-RS before or after the TCI activation command. In this case, the first device 110 may obtain some measurements of CSI-RS corresponding to the beam indicated by the TCI activation command and send the corresponding measurement result in the CSI report before or after receiving the TCI activation command.

In some example embodiments, the first device 110 may determine an available resource before the transmission of the CSI report. In the example embodiment where the first device 110 operates as a UE, if there is an uplink resource available for the CSI report, the first device 110 may transmit the CSI report to the second device 120 using the resource.

Accordingly, the second device 120 may receive (325), from the first device 110, the CSI report that indicates the first CSI measurement result associated with the beam indicated by the beam related indication. In some example embodiments, the first CSI measurement result may be non-OoR. Based on the CSI report containing the non-OoR channel measurement result, the second device 120 may initiate a data transmission to the first device 110 on the beam via the cell.

In some example embodiments, the first device 110 may transmit, to the second device 120, a first indication whether a CSI measurement based on a second reference signal is needed for an accurate channel measurement after transmitting (320) the CSI report. For example, the first device 110 may determine whether the CSI report is based on the first reference signal on a refined beam or a wider beam.

In an example, if the CSI report is based on a SSB on a wider beam corresponding to the indicated TCI, the network may still need to configure the P-CSI-RS or activate the SP-CSI-RS for the legacy channel measurement using a refined beam. In this case, the first device 110 may indicate to the second device 120 that the CSI measurement based on the second reference signal is needed. In this way, the CSI report may not delay the configuration or activation of the S/SP-CSI-RS used for legacy channel measurement.

In some example embodiments, if the CSI measurement based on the second reference signal is needed for the channel measurement, the first device 110 may perform the CSI measurement based on the second reference signal and transmit a valid CSI report to the second device 120 to indicate a second CSI measurement result based on the second reference signal. The second reference signal may be the P-CSI-RS configured or the SP-CSI-RS activated by the second device 120.

In another example, if the CSI report is based on the CSI-RS on a refined beam, for example, a CSI-RS resource is configured for a CSI report on the beam indicated by TCI activation command, then there may be no need for further P/SP-CSI-RS configuration/activation. Accordingly, the first device 110 may indicate to the second device 120 that the second CSI measurement based on the second reference signal is unneeded. In this case, the first device 110 may determine that cell activation for the cell is ended and the cell is activated. The CSI report can be taken as the ending point of cell activation.

At the second device 120, it may be assumed that the CSI report is directed to a refined beam and thus the CSI report can be considered as the ending point of cell activation. In this case, the legacy channel measurement based on P/SP-CSI-RS resource may be skipped, and the cell activation delay may be further reduced.

In some example embodiments, the second device 120 may transmit, to the first device 120, a second indication to enable the CSI report during activation of the cell. In this way, enabling CSI reporting from the first device 110 may be controlled by the second device 120. The second device 120 may indicate if CSI reporting is enabled and/or if SSB or CSI-RS is used as the first reference signal for the CSI reporting. The second indication may be included in a radio resource control (RRC) configuration message for adding the cell and/or a cell activation command for activating the cell.

In some example embodiments, the second device 120 may transmit a cell activation command to the first device 110 to activate the cell. The cell activation command may be transmitted earlier than the TCI activation command in a separate message. Alternatively, the cell activation command and the TCI activation command may be transmitted simultaneously in the same (MAC) message. The cell activation command could be a SCell activation command to activate a SCell or a SCG activation command to activate a PSCell.

Within a time period between the reception of the cell activation command and the reception of the TCI activation command, the first device 110 may transmit an OoR CSI report to the second device 120 to indicate an OoR result. For example, starting from a slot specified in clause 4.3 of TS 38.213 (timing for secondary Cell activation/deactivation) and until the first device 110 has received the TCI activation command, the first device 110 may report OoR CSI if the first device 110 has available resources to report CQI for the cell (for example, SCell). After the first device 110 has received the TCI activation command, the first device 110 may report CSI but NOT OOR CSI (invalid CSI reports) if the first device 110 has available resources to report CQI for the cell.

Example processes of CSI reporting to enable an early data transmission during the SCell activation procedure will be discussed below with reference to FIGS. 4A and 4B. In these examples, as shown in FIGS. 4A and 4B, the first device 110 may operate as a UE 405, and the second device 120 may operate as a network device providing a PCell 410 and Cell2 415 to be activated.

Reference is first made to FIG. 4A which shows an example process 400 of Case 1 of CSI reporting according to some example embodiments of the present disclosure. In Case 1, the UE 405 has been performing L3 measurements on a deactivated SCell.

As shown in FIG. 4A, at 420, the UE 405 may be operating in a RRC connected mode and connect with the PCell 410. Cell2 415 is added to carrier aggregation operation as a SCell. When Cell 2 415 is added as the SCell, at 422, the network may send a RRC message for SCell configuration/addition to indicate if an “early data” transmission (or an “early CSI” report) is enabled during SCell activation. This enabling information can also be included in SCell activation command.

At 424, the UE 405 may perform L3 measurements on the deactivated SCell. At 426, the UE 405 may receive the SCell activation command. At 428, the UE 405 may send a valid or available L3/L2 measurement report including a SSB identification (ID) to inform the latest beam information of SCell. The network may decide a DL transmission beam. Then, at 430, the network may send an TCI activation command to indicate the beam information of the SCell to the UE 405. The network may also forward the TCI state information to the SCell if PCell and SCell are operated in separate gNBs.

The UE 405 may determine the first reference signal based on the available L3/L2 measurements or the received TCI activation command. In an example, at 432, the UE 405 may start a channel measurement on the first reference signal. The first RS may be the SSB or the SSB/CSI-RS in the TCI state or beam indicated by the TCI activation command. At 434, the UE 405 may transmit a CSI report (for example, non-OoR) after the TCI activation command (if there is any UL resource available for the CSI report). This CSI report may allow the network to schedule the UE 405 based on rough beam information.

It is also possible that the channel measurement is performed before the TCI activation command. The UE 405 may determine the measurement result of the first RS based on the available L3/L2 measurements and report the result to the network in the CSI report.

When the network receives the CSI report, the network may schedule the UE 405 for data transmission based on the CSI report. As shown in FIG. 4A, at 436, the network may initiate a data transmission to the UE 405. This can be in parallel with SP/P-CSI-RS based (e.g., a refined beam) channel measurement.

As shown in FIG. 4A, at 438, the network may continue with the configuration or activation of P/SP-CSI-RS based on the TCI activation command for further beam refinement measurements. The CSI report will hereby not delay the continued beam refinement and CSI channel measurements. Thus, the SCell activation delay will not be extended by enabling the CSI report.

FIG. 4B shows an example process 440 of Case 2 of CSI reporting according to some example embodiments of the present disclosure. In Case 2, the Cell2 415 is activated immediately after SCell being added (configured) which may be purely unknown case.

As shown in FIG. 4B, at 442, the UE 405 may perform AGC, cell detection and L1-RSRP measurement as currently for the unknown SCell activation procedure. An optimized beam sweeping factor may be applied and L1-RSRP measurements may be skipped. At 444, the UE 405 may send a L1-RSRP report informing the beam information of the SCell. The L1-RSRP report may be a L1-RSRP report based on the measurements in AGC and cell detection procedures.

Similar to Case 1 as shown in FIG. 4A, the UE may transmit (448) the CSI report (e.g., non-OoR) after the TCI activation command (446) if there is any UL resource available for a CSI report. Data scheduling is hence enabled based on the CSI report. In this example, if the CSI report is based on the refined beam which is used for L1-RSRP measurement, the network may skip configure the P/SP-CSI-RS for a further channel measurement. The CSI report can be taken as the ending point of the SCell activation.

### Example Methods

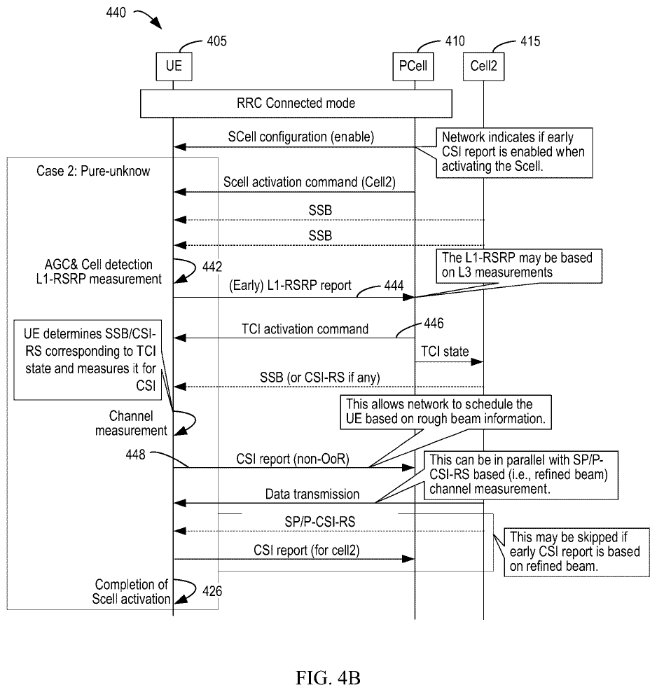

FIG. 5 shows a flowchart of an example method 500 implemented at a first device in accordance with some example embodiments of the present disclosure. For the purpose of discussion, the method 500 will be described from the perspective of the first device 110 in FIG. 1.

At block 510, the first device 110 receives, from the second device 120, a beam related indication for a cell. The beam related indication indicates a beam for a communication via the cell. At block 520, the first device 110 derives a first CSI measurement result based on the received beam related indication. At block 530, the first device 110 transmits, to the second device 120, a CSI report to indicate the first CSI measurement result.

In some example embodiments, the CSI report may transmitted during a cell activation procedure for the cell.

In some example embodiments, the beam related indication may comprise a TCI activation command.

In some example embodiments, the first CSI measurement result may be OoR.

In some example embodiments, the first device 110 may receive, from the second device, a cell activation command to activate the cell, earlier than or simultaneous with the beam related indication.

In some example embodiments, the first device 110 may transmit, to the second device, an Out-of-Range (OoR) CSI report indicating an OoR result, within a time period between the reception of the cell activation command and the reception of the beam related indication.

In some example embodiments, the first device 110 may determine, based on the beam related indication, a first reference signal associated with the beam.

In some example embodiments, the first reference signal may comprise at least one of: a synchronization signal block (SSB), or a CSI reference signal (CSI-RS).

In some example embodiments, the first device 110 may transmit, to the second device, a first indication whether a CSI measurement based on a second reference signal is needed for channel measurement after the CSI report.

In some example embodiments, the first device 110 may in response to the CSI measurement based on the second reference signal being needed for the channel measurement, transmit, to the second device, a valid CSI report to indicate a CSI measurement result based on the second reference signal.

In some example embodiments, the first device 110 may in response to the CSI measurement based on the second reference signal being unneeded for the channel measurement, determine that cell activation for the cell is ended and the cell is activated.

In some example embodiments, the first device 110 may receive, from the second device, a second indication to enable the CSI report during activation of the cell.

In some example embodiments, the second indication may be included in at least one of a radio resource control (RRC) configuration message or a cell activation command.

In some example embodiments, the first device 110 may receive, from the second device, a data transmission on the beam via the cell.

In some example embodiments, the first device 110 may based on a determination that there is a resource available for the CSI report, transmit, to the second device, the CSI report using the resource.

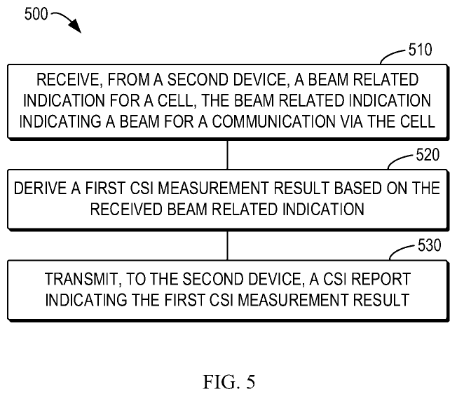

FIG. 6 shows a flowchart of an example method 600 implemented at a second device in accordance with some example embodiments of the present disclosure. For the purpose of discussion, the method 600 will be described from the perspective of the second device 120 in FIG. 1.

At block 610, the second device 120 transmits, to the first device 110, a beam related indication for a cell. The beam related indication indicates a beam for a communication via the cell. At block 620, the second device 120 receives, from the first device 110, a CSI report to indicate a first CSI measurement result associated with the beam.

In some example embodiments, the beam related indication may comprise a TCI activation command.

In some example embodiments, the CSI report may be received during a cell activation procedure for the cell.

In some example embodiments, the first CSI measurement result may be non-OoR.

In some example embodiments, the second device 120 may transmit, to the first device 110, a cell activation command to activate the cell, earlier than or simultaneous with the beam related indication.

In some example embodiments, the second device 120 may receive, from the first device 110, an OoR CSI report to indicate an OoR result, within a time period between the transmission of the cell activation command and the transmission of the TCI activation command.

In some example embodiments, the second device 120 may receive, from the first device 110, a non-OoR CSI report to indicate the measured CSI report, within a time period between the transmission of the TCI activation command and the configuration or activation of P/SP-CSI-RS for channel measurement or the reception of a valid CSI report.

In some example embodiments, the second device 120 may receive, from the first device 110, a first indication whether a CSI measurement based on a second reference signal is needed for channel measurement after the CSI report.

In some example embodiments, the second device 120 may in response to the CSI measurement based on the second reference signal being needed for the channel measurement, receive, from the first device 110, a valid CSI report to indicate a second CSI measurement result based on the second reference signal.

In some example embodiments, the second device 120 may in response to the CSI measurement based on the second reference signal being unneeded, determine that cell activation for the cell is ended and the cell is activated.

In some example embodiments, the second device 120 may transmit, to the first device 110, a second indication to enable the CSI report during activation of the cell.

In some example embodiments, the second indication may be included in at least one of a RRC configuration message for adding the cell or a cell activation command for the cell.

In some example embodiments, the second device 120 may initiate, based on the CSI report, an data transmission to the first device on the beam via the cell.

All operations and features related to the first device 110 and the second device 120 as described above with reference to FIGS. 1 to 4B are likewise applicable to the methods 500 and 600 and have similar effects. For the purpose of simplification, the details will be omitted.

### Example Apparatus, Device and Medium

In some example embodiments, a first apparatus capable of performing any of the method 500 (for example, the first device 110 in FIG. 1) may comprise means for performing the respective operations of the method 500. The means may be implemented in any suitable form. For example, the means may be implemented in a circuitry or software module. The first apparatus may be implemented as or included in the first device 110 in FIG. 1.

In some example embodiments, the first apparatus comprises means for receiving, from a second device, a beam related indication for a cell, the beam related indication indicating a beam for a communication via the cell; means for deriving a first channel state information (CSI) measurement result based on the received beam related indication; and means for transmitting, to the second device, a CSI report indicating the first CSI measurement result.

In some example embodiments, the CSI report is transmitted during a cell activation procedure for the cell.

In some example embodiments, the beam related indication comprises a transmission configuration indication (TCI) activation command.

In some example embodiments, the first CSI measurement result is non-Out-of-Range (OoR).

In some example embodiments, the first apparatus further comprises: means for receiving, from the second device, a cell activation command to activate the cell, earlier than or simultaneous with the beam related indication.

In some example embodiments, the first apparatus further comprises: means for transmitting, to the second device, an Out-of-Range (OoR) CSI report indicating an OoR result, within a time period between the reception of the cell activation command and the reception of the beam related indication.

In some example embodiments, the first apparatus further comprises: means for determining, based on the beam related indication, a first reference signal associated with the beam.

In some example embodiments, the first reference signal comprises at least one of: a synchronization signal block (SSB), or a CSI reference signal (CSI-RS).

In some example embodiments, the first apparatus further comprises: means for transmitting, to the second device, a first indication whether a CSI measurement based on a second reference signal is needed for channel measurement after the CSI report.

In some example embodiments, the first apparatus further comprises: in response to the CSI measurement based on the second reference signal being needed for the channel measurement, means for transmitting, to the second device, a valid CSI report to indicate a CSI measurement result based on the second reference signal.

In some example embodiments, the first apparatus further comprises: means for in response to the CSI measurement based on the second reference signal being unneeded for the channel measurement, determining that cell activation for the cell is ended and the cell is activated.

In some example embodiments, the first apparatus further comprises: means for receiving, from the second device, a second indication to enable the CSI report during activation of the cell.

In some example embodiments, the second indication is included in at least one of a radio resource control (RRC) configuration message or a cell activation command.

In some example embodiments, the first apparatus further comprises: means for receiving, from the second device, a data transmission on the beam via the cell.

In some example embodiments, means for transmitting the CSI report comprises: means for based on a determination that there is a resource available for the CSI report, transmitting, to the second device, the CSI report using the resource.

In some example embodiments, the first apparatus further comprises means for performing other operations in some example embodiments of the method 500 or the first device 110. In some example embodiments, the means comprises at least one processor; and at least one memory storing instructions that, when executed by the at least one processor, cause the performance of the first apparatus.

In some example embodiments, a second apparatus capable of performing any of the method 600 (for example, the second device 120 in FIG. 1) may comprise means for performing the respective operations of the method 600. The means may be implemented in any suitable form. For example, the means may be implemented in a circuitry or software module. The second apparatus may be implemented as or included in the second device 120 in FIG. 1.

In some example embodiments, the second apparatus comprises means for transmitting, to a first device, a beam related indication for a cell, the beam related indication indicating a beam for a communication via the cell; and means for receiving, from the first device, a channel state information (CSI) report indicating a first CSI measurement result associated with the beam.

In some example embodiments, the beam related indication comprises a transmission configuration indication (TCI) activation command.

In some example embodiments, the CSI report is received during a cell activation procedure for the cell.

In some example embodiments, the first CSI measurement result is non-Out-of-Range (OoR).

In some example embodiments, the second apparatus further comprises: means for transmitting, to the first device, a cell activation command to activate the cell, earlier than or simultaneous with the beam related indication.

In some example embodiments, the second apparatus further comprises: means for receiving, from the first device, an Out-of-Range (OoR) CSI report indicating an OoR result, within a time period between the transmission of the cell activation command and the transmission of the beam related indication.

In some example embodiments, the second apparatus further comprises: means for receiving, from the first device, a first indication whether a CSI measurement based on a second reference signal is needed for channel measurement after the CSI report.

In some example embodiments, the second apparatus further comprises: means for transmitting, to the first device, a second indication to enable the CSI report during activation of the cell.

In some example embodiments, the second indication is included in at least one of a radio resource control (RRC) configuration message or a cell activation command.

In some example embodiments, the second apparatus further comprises: means for initiating, based on the CSI report, a data transmission to the first device on the beam via the cell.

In some example embodiments, the second apparatus further comprises means for performing other operations in some example embodiments of the method 600 or the second device 120. In some example embodiments, the means comprises at least one processor; and at least one memory storing instructions that, when executed by the at least one processor, cause the performance of the second apparatus.

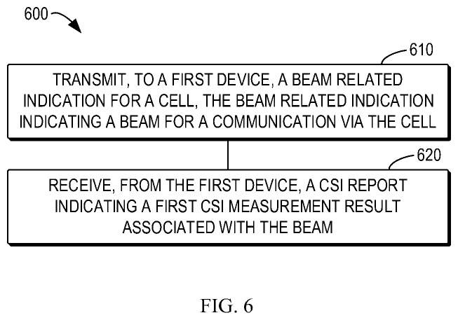

FIG. 7 is a simplified block diagram of a device 700 that is suitable for implementing example embodiments of the present disclosure. The device 700 may be provided to implement a communication device, for example, the first device 110 or the second device 120 as shown in FIG. 1. As shown, the device 700 includes one or more processors 710, one or more memories 720 coupled to the processor 710, and one or more communication modules 740 coupled to the processor 710.

The communication module 740 is for bidirectional communications. The communication module 740 has one or more communication interfaces to facilitate communication with one or more other modules or devices. The communication interfaces may represent any interface that is necessary for communication with other network elements. In some example embodiments, the communication module 740 may include at least one antenna.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The instructions of the program 730 may include instructions for performing operations/acts of some example embodiments of the present disclosure. The program 730 may be stored in the memory, e.g., the ROM 724. The processor 710 may perform any suitable actions and processing by loading the program 730 into the RAM 722.

The example embodiments of the present disclosure may be implemented by means of the program 730 so that the device 700 may perform any process of the disclosure as discussed with reference to FIG. 1 to FIG. 6. The example embodiments of the present disclosure may also be implemented by hardware or by a combination of software and hardware.

In some example embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

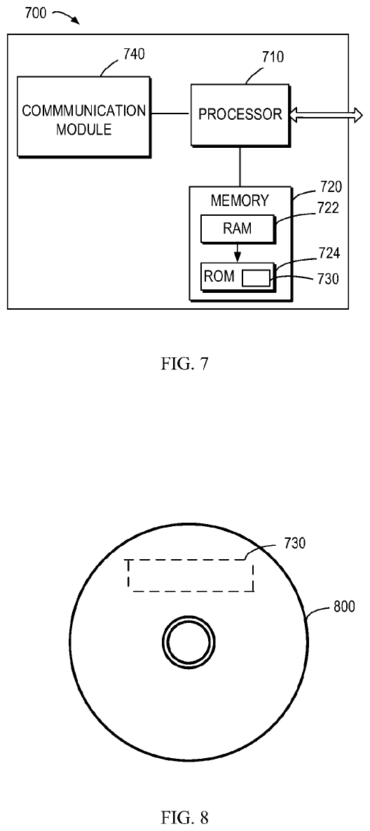

FIG. 8 shows an example of the computer readable medium 800 which may be in form of CD, DVD or other optical storage disk. The computer readable medium 800 has the program 730 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first device, comprising:
at least one processor; and
at least one memory storing instructions that, when executed by the at least one processor, cause the first device at least to perform:
receiving, from a second device, a beam related indication for a cell, the beam related indication indicating a beam for a communication via the cell;
deriving a first channel state information (CSI) measurement result based on the received beam related indication; and
transmitting, to the second device, a CSI report indicating the first CSI measurement result.

2. The first device of claim 1, wherein the CSI report is transmitted during a cell activation procedure for the cell.

3. The first device of claim 1, wherein the beam related indication comprises a transmission configuration indication (TCI) activation command.

4. The first device of claim 1, wherein the first CSI measurement result is non-Out-of-Range (OoR).

5. The first device of claim 1, further caused at least to perform:
receiving, from the second device, a cell activation command to activate the cell, earlier than or simultaneous with the beam related indication.

6. The first device of claim 5, further caused at least to perform:
transmitting, to the second device, an Out-of-Range (OoR) CSI report indicating an OoR result, within a time period between the reception of the cell activation command and the reception of the beam related indication.

7. The first device of claim 1, further caused at least to perform:
determining, based on the beam related indication, a first reference signal associated with the beam.

8. The first device of claim 7, wherein the first reference signal comprises at least one of:
a synchronization signal block (SSB), or
a CSI reference signal (CSI-RS).

9. The first device of claim 1, further caused at least to perform:
transmitting, to the second device, a first indication whether a CSI measurement based on a second reference signal is needed for channel measurement after the CSI report.

10. The first device of claim 9, further caused at least to perform:
in response to the CSI measurement based on the second reference signal being needed for the channel measurement,
transmitting, to the second device, a valid CSI report to indicate a CSI measurement result based on the second reference signal.

11. The first device of claim 9, further caused at least to perform comprising:
in response to the CSI measurement based on the second reference signal being unneeded for the channel measurement, determining that cell activation for the cell is ended and the cell is activated.

12. The first device of claim 1, further caused at least to perform:
receiving, from the second device, a second indication to enable the CSI report during activation of the cell.

13. The first device of claim 12, wherein the second indication is included in at least one of a radio resource control (RRC) configuration message or a cell activation command.

14. The of first device claim 1, further caused at least to perform:
receiving, from the second device, a data transmission on the beam via the cell.

15. The first device of claim 1, wherein transmitting the CSI report comprises:
based on a determination that there is a resource available for the CSI report, transmitting, to the second device, the CSI report using the resource.

16. A second device, comprising:
at least one processor; and
at least one memory storing instructions that, when executed by the at least one processor, cause the second device at least to perform:
transmitting, to a first device, a beam related indication for a cell, the beam related indication indicating a beam for a communication via the cell; and
receiving, from the first device, a channel state information (CSI) report indicating a first CSI measurement result associated with the beam.

17-19. (canceled)

20. The second device of claim 16, further caused at least to perform:
transmitting, to the first device, a cell activation command to activate the cell, earlier than or simultaneous with the beam related indication.

21. The second device of claim 20, further caused at least to perform:
receiving, from the first device, an Out-of-Range (OoR) CSI report indicating an OoR result, within a time period between the transmission of the cell activation command and the transmission of the beam related indication.

22. The second device of claim 16, further caused at least to perform:
receiving, from the first device, a first indication whether a CSI measurement based on a second reference signal is needed for channel measurement after the CSI report.

23. The second device of claim 16, further caused at least to perform:
transmitting, to the first device, a second indication to enable the CSI report during activation of the cell.

24-30. (canceled)
